(19) United States
(12) Patent Application Publication
(10) Pub. No.: US 2026/0175305 A1
(43) Pub. Date: Jun. 25, 2026

(54) HAND-HELD WORK APPARATUS FOR PROCESSING A MATERIAL

(71) Applicant: ANDREAS STIHL AG & Co. KG, Waiblingen (DE)

(72) Inventors: Tobias WAGNER, Berglen (DE); Denis EHRLER, Wernau (DE); Patrick SCHINDLER, Weilheim an der Teck (DE); Johann-Sebastian RENZ, Gomaringen (DE)

(73) Assignee: ANDREAS STIHL AG & Co. KG, Waiblingen (DE)

(21) Appl. No.: 19/423,077

(22) Filed: Dec. 17, 2025

(30) Foreign Application Priority Data
Dec. 19, 2024 (DE) 10 2024 139 043.3
Dec. 19, 2024 (DE) 10 2024 139 044.1

(51) Int. Cl. B23D 45/16; B23D 47/12; B28D 7/02

(52) U.S. Cl. CPC B23D 45/16; B23D 47/12; B28D 7/02

(57) ABSTRACT

The invention relates to a hand-held work apparatus for processing a material. The work apparatus comprises a tool which, in an operating state of the work apparatus, is configured for cutting, separating, and/or grinding the material. The work apparatus comprises reduced wear, in particular with respect to a liquid medium.

### CROSS REFERENCE TO RELATED APPLICATIONS

This application, which claims priority under 35 U.S.C. § 119 of German Application No. DE 10 2024 139 043.3, filed on Dec. 19, 2024 and German Application No. DE 10 2024 139 044.1 filed on Dec. 19, 2024, the disclosures of which are incorporated by reference.

### BACKGROUND OF THE INVENTION

The present invention lies in the field of device technology and relates to a hand-held work apparatus for processing a material.

Hand-held work apparatuses are configured differently depending on their intended purpose and area of application and must meet a variety of requirements. For example, in the construction industry, hand-held work apparatuses for processing a material in the form of cutting, separating, and/or grinding should generally be robust, easy to maintain, and durable.

A particular challenge for hand-held work apparatuses is, above all, protecting them against a penetration of a medium into the work apparatus. Depending on the working environment and/or the material being processed, dusts and/or slurries can be produced, for example, and their penetration into the work apparatus should be avoided.

### SUMMARY OF THE INVENTION

It is an object of the present invention to provide a hand-held work apparatus for processing a material, which is characterized above all by an improved resistance to external influences, in particular to a flowing medium, which is accompanied, for example, by less wear on the work apparatus.

The object is solved by the features of independent claim 1. Further embodiments and applications of the present invention are apparent from the dependent claims and are explained in more detail in the following description with partial reference to the figures.

According to a first general aspect, the present invention relates to a hand-held work apparatus for processing a material, comprising: •a tool which, in an operating state of the work apparatus, is configured for cutting, separating, and/or grinding the material; •a drive unit which is coupled to the tool via a drive means in order to drive the tool; •a boom which extends essentially in a longitudinal direction between the drive unit and the tool and is configured to rotatably support the tool about a rotation axis by means of a tool bearing unit; wherein a cover housing part is arranged on the boom, which extends essentially along the longitudinal direction and comprises a housing end edge, which is, in particular, arranged facing toward the tool and/or arranged opposite the tool in a transverse direction, wherein a drainage structure with at least one drainage structure section is arranged on the cover housing part, which drainage structure section is formed, originating from the housing end edge 101, in a raised manner in order to delimit a flow surface on the cover housing part for a flowing medium essentially in the longitudinal direction and, in particular, to avoid or at least negligibly reduce the (flowing) medium from penetrating into a gap of the work apparatus.

The present invention provides a work apparatus with a drainage structure arranged on a cover housing part, which limits an (external) flowing medium in a defined direction and ensures drainage of the flowing medium. In the work apparatus, a further movement of the flowing medium along the cover housing part can thus be avoided, so that, in particular, a penetration of the medium into the work apparatus, for example at a low-lying position, is avoided or at least negligibly reduced.

The work apparatus can be configured for processing different materials, in particular in the form of material bodies. The material can be, for example, a mineral material in the form of a brick, sand-lime brick, concrete block, or aerated concrete block. The work apparatus can be, for example, a cut-off grinder with a tool in the form of a tool disc. The tool disc can be configured in the operating state of the work apparatus for cutting, separating, and/or grinding a material.

The flowing medium can be a medium of an environment within which the work apparatus is operated. The flowing medium can be water resulting from raindrops. In addition or alternatively, the flowing medium can be or comprise a medium that is (actively) supplied to the tool for cooling, lubricating, and/or binding a processed material, for example in the form of dust. The flowing medium can be a mixture of water and processed material, for example in the form of slurry. In the following, for improved readability, the term “flowing” is partly omitted in connection with the medium.

In an embodiment of the work apparatus as a cut-off grinder with a tool disc and with a boom for arranging and bearing the tool disc, as well as for guiding a belt for driving the tool disc, a flow of a mineral slurry, for example, along the cover housing part in the direction of the drive unit can be prevented, which in particular leads to an optimization of the wear behavior. The drainage structure is characterized, for example, by a simple and robust design.

The flow surface can, for example, be formed in sections as essentially planar (flat). In addition or alternatively, the flow surface can be formed in sections as convexly curved or concavely curved.

The longitudinal direction can be a direction in and/or along which the boom extends maximally and thus to its greatest length. The transverse direction can be a direction that is arranged and/or oriented perpendicular to the longitudinal direction. The transverse direction can be arranged and/or oriented parallel to an axial direction of a drive shaft of the drive unit. In addition or alternatively, the transverse direction can be arranged and/or oriented parallel to the rotation axis of the tool bearing unit.

According to a further aspect of the present invention, it can be provided that the at least one drainage structure section extends continuously, in particular essentially steadily, essentially along the longitudinal direction toward the drive unit and essentially along the transverse direction away from the housing end edge, in order to essentially collect the medium during the operating state in at least one defined location of the work apparatus and to discharge it in at least one drainage direction.

The at least one defined location can comprise at least one position and/or at least one orientation of the work apparatus, in each case in which the medium flows along the cover housing part essentially in the direction of the drive unit, in particular as a result of the effect of a gravitational force. In addition or alternatively, the gap can be formed by a plug connection essentially in the longitudinal direction between the cover housing part and a further cover housing part which is at least partially arranged on the boom.

The at least one defined location can comprise an orientation of the work apparatus in which the boom and/or the longitudinal direction of the boom is arranged and/or oriented at an angle to a vertical line, in particular such that the tool is at a greater height above the ground than the drive unit. This location can occur, for example, when working overhead. In this case, for example, the boom is inclined at an angle relative to a vertical wall, with the angle being less than 90°. The drainage structure can comprise at least one further drainage structure section which is arranged and/or formed on one side of the cover housing part which is arranged opposite the side with the at least one drainage structure section. In other words, at least one drainage structure section, for example in the form of a rib, can be arranged and/or formed on an upper side of the cover housing part and at least one further drainage structure section, for example in the form of a rib, can be arranged and/or formed on a lower side of the cover housing part. In analogy to the at least one drainage structure section, the at least one further drainage structure section can be formed, originating from the housing end edge, in a raised manner from a corresponding housing end edge of the cover housing part. This can be possible, for example, in a configuration of the work apparatus in which the tool can be arranged on opposite sides of the boom. In other words, the boom can be configured for arranging the tool on a first (left-hand) side and on an opposite second (right-hand) side, for example, to accommodate confined spaces, such as at wall transition areas.

The cover housing part can be formed in multiple parts and can comprise, for example, two or more cover housing part segments. The drainage structure, i.e., at least one drainage structure section, can be arranged and/or formed on a first cover housing segment and/or on a second cover housing segment. The first cover housing segment can be arranged in sections opposite the drive unit. The first cover housing segment can be arranged (on the boom) away from the tool. The second cover housing segment can be arranged in sections opposite the tool. The second cover housing segment can be arranged (on the boom) close to the tool.

According to a further aspect of the present invention, it can be provided that the drainage structure is characterized, along at least one drainage direction, in particular on at least one housing outer side of the cover housing part, at least in sections, by at least one of the following formations: rib-shaped, tube-shaped, channel-shaped, and/or duct-shaped, each with a semi-open profile or a closed profile.

This allows, for example on the one hand, a simple and robust design of the drainage structure to be realized, and, on the other hand, an effective limiting of the medium with subsequent drainage of the medium to be ensured.

It is possible that the at least one drainage structure section is formed as a rib, wherein, in a top view of the work apparatus, in particular on the side of the flow surface, the rib forms an (resulting and/or idealized) angle with the housing end edge which is at least greater than 90°.

The rib can extend, in sections, essentially straight line. The rib can be arranged, extending from the housing end edge of the cover housing part, obliquely toward the housing end edge. Depending on the formation of the cover housing, the rib can be formed adapted to an outer surface of the cover housing part and/or extend along an outer surface of the cover housing part.

According to a further aspect of the present invention, the work apparatus can comprise a supply unit with a supply line for supplying a liquid medium to the tool in order to at least cool the tool and/or bind processed material during the operating state; wherein the supply line comprises a line section which is formed to be shape-variable and/or essentially reversibly deformable, wherein the drainage structure comprises a second drainage structure section which is configured to form a releasable essentially form-fitting and/or releasable essentially force-fitting connection with the line section, in particular is configured channel-shaped or duct-shaped, in order to guide the medium, in particular with the (processed) bound material, together with the line section in at least one drainage direction.

The provided liquid medium can be a liquid and/or pressurized cooling medium for the tool, in particular in the form of water. By providing a liquid medium to the tool and/or in the area of the tool, it is possible to essentially bind a processed material, for example in the form of dust, during the operating state of the tool, which is accompanied by the generation of a liquid and/or at least flowable mixture.

The supply unit can in turn be connected to an external source for the liquid medium in the form of a cooling medium and/or comprise a shut-off element for the liquid medium, for example in the form of a manually operable valve.

Due to the configuration of the second drainage structure section, it is on the one hand possible to releasably fasten the line section of the supply line to the drainage structure and/or through the drainage structure and/or to guide it in at least one defined direction toward the tool of the work apparatus. On the other hand, the liquid medium together with the (processed) bound material in the form of a mixture can simultaneously be guided in the at least one drainage direction, so as to drain it from the cover housing part. This can be ensured in particular by a channel-shaped or duct-shaped configuration of the second drainage structure section of the drainage structure.

It is possible that the drainage structure comprises a third drainage structure section between a first housing outer side of the cover housing part and a second housing outer side of the cover housing part, in particular between a rib-shaped formation, and a channel-shaped or duct-shaped formation of the drainage structure, which is formed in a trough-shaped or pocket-shaped manner in order to provide a barrier for the medium to pass to the second housing outer side and to partially retain the medium in the third drainage structure section.

By a partially retained liquid medium, in particular in the form of water, this medium can contribute to guiding and/or draining additional medium that arrives via the flow surface, between the first outer surface and the second outer surface of the housing.

According to a further aspect of the present invention, it can alternatively be provided that the drainage structure is arranged on at least a first housing outer side of the cover housing part and on a second housing outer side of the cover housing part, wherein the first housing outer side and the second housing outer side are oriented and/or arranged differently to each other, in particular are oriented essentially perpendicularly to each other, in order to discharge the medium, in particular in the form of a mixture, essentially without backflow.

It is possible that the drainage structure comprises a fourth drainage structure section, which is, in the longitudinal direction and within the flow area, arranged spaced apart from the at least one drainage structure section and which is formed, originating from the housing end edge, in a raised manner; wherein the at least one drainage structure section is arranged to discharge a first portion of the medium, and wherein the fourth drainage structure section is arranged to discharge a second portion of the medium, wherein the second portion is larger than the first portion.

According to a further aspect of the present invention, it can be provided that the drainage structure is arranged, in the longitudinal direction, relative to the drive unit in front of a plug section of the cover housing part and/or adjacent to a plug section of the cover housing part, wherein the plug section is configured to form a plug connection with a further cover housing part which is at least partially arranged on the boom.

According to a further aspect of the present invention, it can be provided that the drainage structure is produced together with the cover housing part as a separate individual part, in particular integrally in one piece, particularly preferably by at least one of the following processes: an injection process, a casting process, a sintering process, a 3D printing process, a shrinkage process, a curing process.

According to a further general aspect, the present invention relates to a hand-held work apparatus for processing a material, comprising: •a tool which, in an operating state of the tool, is configured for cutting, separating, and/or grinding the material; •a drive unit which is coupled to the tool in order to drive the tool; wherein the drive unit comprises a drive shaft with a drive element for coupling with the tool, wherein a functional part is arranged on the drive shaft, which is arranged, in particular on an outer side of the drive unit, in an axial direction of the drive shaft, spaced apart opposite to a shaft bearing unit and at least partially to a drive housing part of the drive unit for receiving the shaft bearing unit, wherein the functional part is configured to essentially keep a medium arriving during the operating state away from the shaft bearing unit, and to convey it away and/or discharge at the drive housing part in at least one direction, in particular in order to protect the shaft bearing unit.

With the present invention, a work apparatus can furthermore be provided in which a penetration of a medium toward a shaft bearing unit can be avoided or at least reduced to a negligible extent. The medium can be configured as disclosed herein. The work apparatus can be configured, for example, as a cut-off grinder, in particular as disclosed herein, or as a rock cutter.

The functional part, in particular in conjunction with the drive housing part, ensures that an arriving medium is essentially kept away from the shaft bearing unit and is further conveyed away and/or discharged at the drive housing part in at least one direction.

The functional part is formed in particular as an essentially rotationally symmetrical part and is characterized, for example, by a maximum outer diameter and a minimum outer diameter. The functional part is arranged, in the axial direction of the drive shaft, spaced apart opposite to the shaft bearing unit and additionally to the drive housing part, in particular to a housing end face of the drive housing part. In other words, the functional part is arranged, in particular, with the formation of a distance both to the shaft bearing unit and with the formation of a distance to the drive housing part, in particular to the housing end face. In a view in and/or along the axial direction, the functional part thus covers in particular the shaft bearing unit and also at least partially the drive housing part.

It is possible that the functional part is configured to subject the medium, as a result of a rotational movement of the drive shaft about an rotation axis, to a centrifugal force in order to accelerate the medium essentially in the at least one direction, which is, in particular, accompanied by an (active) (path) conveyance of the medium (starting from the shaft bearing unit) at the drive housing part. In other words, the drive housing part serves to provide a conveying surface for the medium to be conveyed in at least one direction.

The at least one direction can in particular comprise a radial direction and/or a circumferential direction of the drive shaft and/or the drive element.

According to a further aspect of the present invention, it can be provided that, in a sectional view along the axial direction, the functional part is characterized, in a radial direction, by an essentially cascade-shaped contour profile, in particular by an essentially two-stage cascade-shaped contour.

The functional part can be adapted to and/or formed complementary to respective end faces of the shaft bearing unit and/or the drive housing part, for example as a stepped ring-shaped individual part. The functional part can additionally or alternatively be formed disc-shaped. In other words, the functional part can be formed as a centrifugal disc with respect to the medium.

According to a further aspect of the present invention, it can be provided that the drive housing part comprises a housing end face and wherein the functional part comprises a functional end face, wherein, in the axial direction, a conveying gap is formed between the housing end face and the functional end face in order, as a result of a rotational movement of the drive shaft about a rotation axis, to set a medium located in the conveying gap into a movement, in particular into a rotational movement about the rotation axis, by means of the functional end face

The conveying gap can be characterized by a width in the axial direction.

It is possible that the housing end face and the functional end face are each formed essentially planar (flat) and/or are each arranged parallel to each other, or that the conveying gap expands, at least in sections, in a radial direction toward a functional outer surface of the functional part.

The functional outer surface can be a surface of the functional part extending in the circumferential direction.

According to a further aspect of the present invention, it can be provided that the conveying gap transitions, in a radial direction toward the drive shaft, into a functional step of the functional part, which limits the conveying gap in the radial direction, wherein the functional step extends in the axial direction toward the shaft bearing unit and, along the axial direction, forms an axial gap with the drive housing part.

The axial gap can be characterized by a width in the radial direction. The axial gap can be arranged circumferentially in the circumferential direction and extend in sections along the axial direction.

It is possible that a width of the axial gap in the radial direction is at least equal to or smaller than a width of the conveying gap in the axial direction.

This can, for example, avoid or at least significantly reduce a further movement of the arriving medium.

According to a further aspect of the present invention, it can be provided that, in a radial direction toward a functional outer surface of the functional part, the housing end face extends at least as far as the functional end face in the radial direction, in order to essentially discharge the medium conveyed in at least one direction at the housing end face, wherein, in particular, the housing end face is characterized by a circular ring-shaped cross-section which is at least equal to or greater than a circular ring-shaped cross-section of the functional end face.

The functional end face can be characterized by a defined minimum cross-sectional area.

According to a further aspect of the present invention, it can be provided that the functional part comprises a retaining edge and/or a groove, each of which is arranged at a defined radial position in a radial direction and extends in a circumferential direction, wherein the retaining edge and/or the groove is configured, after an operating state, to essentially retain, in particular in the direction of the shaft bearing unit, to essentially collect and/or to essentially discharge medium, in particular a residual portion of medium, from the functional part.

The functionality of the retaining edge and/or the groove can, for example, be realized in a defined location in which the work apparatus is parked on a floor after an operating state and the drive shaft is arranged in an essentially (resulting and/or idealized) horizontal orientation. In this location, the work apparatus can be cleaned, for example, with a water jet, whereby a portion of the water from the water jet can penetrate to the shaft bearing unit if no retaining edge and/or groove is present.

It is possible that the functional part is produced as a separate individual part, in particular as a stepped ring-shaped individual part, which is fastened to the drive element, arranged on the drive element or arranged spaced apart to the drive element, or that the drive element is produced (together) with the functional part as a separate individual part, in particular integrally in one piece, most preferably by at least one of the following processes: a milling process, a turning process.

### BRIEF DESCRIPTION OF THE DRAWINGS

The embodiments and features of the present invention described above can be combined with each other in any manner or as appropriate. Further or other details and advantageous effects of the present invention are explained in more detail below with reference to the accompanying figures.

It shows:

FIG. 1 a first embodiment of the hand-held work apparatus according to the present invention in a first perspective view, wherein the work apparatus is in a first location;

FIG. 2 the work apparatus from FIG. 1 in a second perspective view, wherein the work apparatus is in a second location;

FIG. 3 a section of the work apparatus from FIG. 2 (section Y) in an enlarged view;

FIG. 4 the work apparatus from FIG. 1 in a third perspective view, wherein the work apparatus is shown partially in section and wherein some units and elements of the work apparatus are hidden;

FIG. 5 the work apparatus from FIG. 4 in a sectional view, wherein some units and elements of the work apparatus are hidden;

FIG. 6 a section of the work apparatus from FIG. 5 (section Z) in an enlarged view.

Identical or functionally equivalent devices, units, or elements are marked with the same reference signs in the figures. For the sake of clarity, reference is also made in part to the description of other embodiments and/or figures in order to avoid repetition.

### DETAILED DESCRIPTION

The following detailed description of the embodiments shown in the figures serves for further illustration or clarification and is not intended to limit the scope of the present invention in any way.

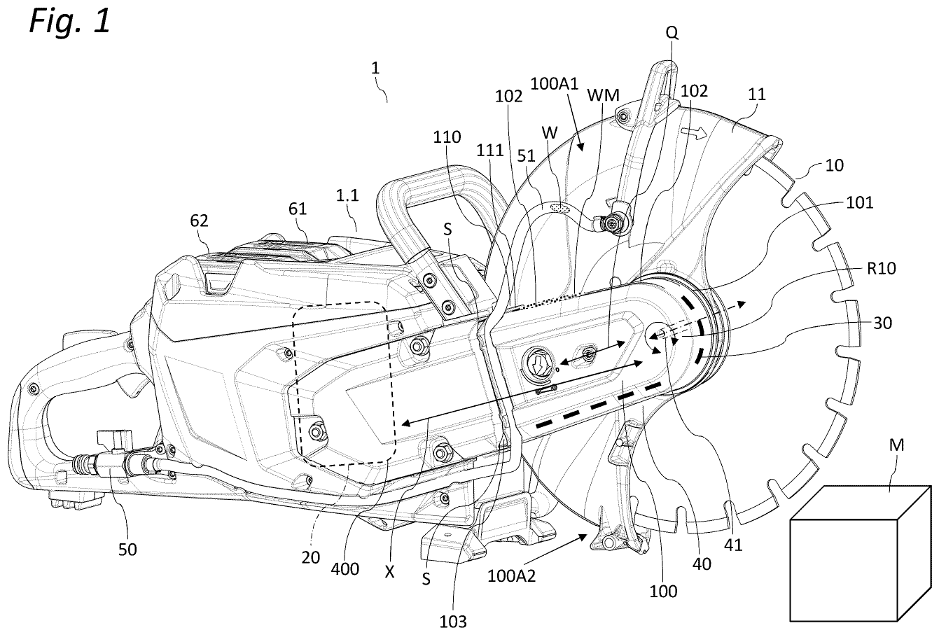

FIG. 1 shows a first embodiment of a hand-held work apparatus 1 according to the present invention in a first perspective view, wherein the work apparatus 1 is in a first location. The first location is a parked location of the hand-held work apparatus 1, in which the hand-held work apparatus 1 is parked on a floor. The floor is essentially planar (level) and/or essentially horizontally oriented. For the sake of simplicity, the term “hand-held” is omitted in connection with the work apparatus 1 in the following.

The work apparatus 1 can be a hand-held, hand-guided, hand-operated, hand-carried, and/or mobile electric tool 1. Alternatively, the work apparatus 1 can be configured as a combustion engine-driven work apparatus 1. The work apparatus 1 is configured for processing a material M. The material M can be a mineral material, for example in the form of a brick, a concrete block, or a sand-lime brick. The work apparatus 1 comprises a tool 10 which, in an operating state of the work apparatus 1, is configured for cutting, separating, and/or grinding the material M. In the first embodiment shown, the work apparatus 1 is formed as a so-called cut-off grinder 1. Alternatively, further and/or other embodiments of the work apparatus 1 are possible. In the following, the work apparatus 1 is described by way of example based on its configuration as a cut-off grinder 1.

The tool 10 is disc-shaped, i.e., formed as a tool disc. In other words, the tool 10 is formed as a cutting and/or grinding disc. The tool 10 is covered in sections by a protective cover 11. The protective cover 11 is formed hood-shaped. The protective cover 11 covers the tool 10 in sections in the form of a protective hood 11. The tool 10 is, in particular, an interchangeable tool 10.

The cutting and/or grinding disc 10 is used, for example, for processing the material M in the form of a brick. The brick can, for example, be a component of a wall of a building and be arranged at a corresponding height relative to a floor.

The work apparatus 1 comprises, as a cut-off grinder 1, in particular a supply unit 50 with a supply line 51 for supplying a flowable and/or liquid medium W at the tool 10 and/or in the area of the tool 10, in order, during the operating state, to at least cool the tool 10 and/or to essentially bind processed material M, thereby generating a medium in the form of a mixture WM. The medium W can be, for example, water, which is supplied to the tool 10 via the supply unit 50 and the supply line 51. In other words, the supply line 51 represents a water line 51 of the cut-off grinder 1 for binding dust M generated during operation of the cut-off grinder 1 and thus the cutting and/or grinding disc 10 by processing the material M using water W, which is accompanied by the generation of a water-material particle mixture WM.

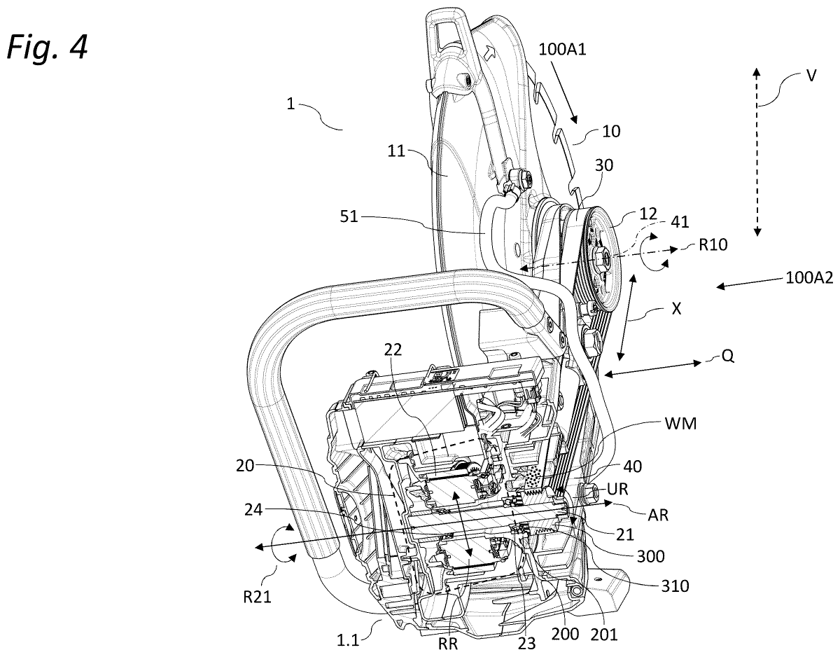

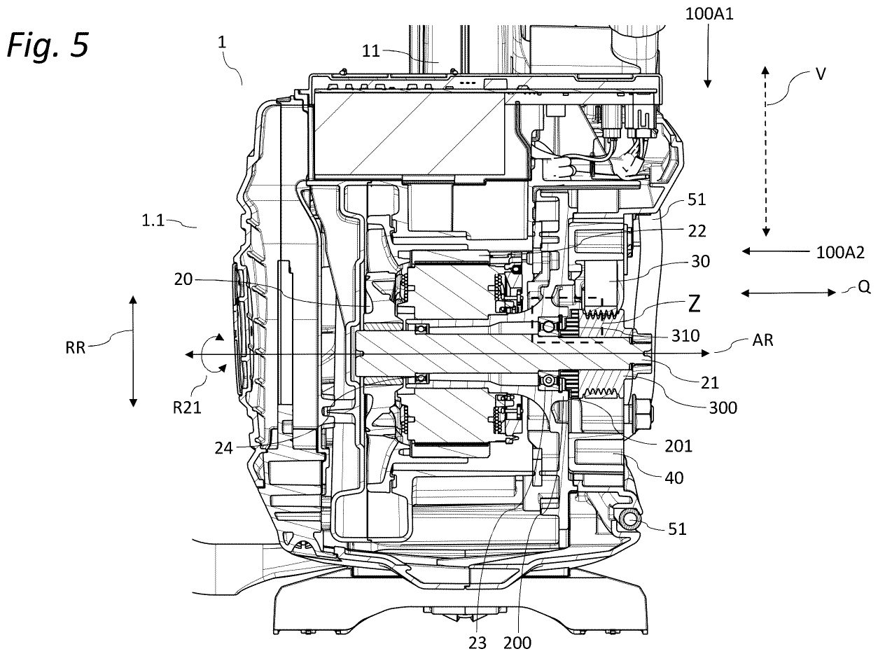

To drive the tool 10, the work apparatus 1 comprises a drive unit 20. The drive unit 20 is coupled to the tool 10 via a drive means 30 in order to drive the tool 10, in particular to drive it in the operating state. The drive unit 20 is schematically indicated by a dashed line in the illustration in FIG. 1, with reference also being made to FIGS. 4 and 5, which show part of the drive unit 20 and are described in more detail below.

In the present embodiment, the drive unit 20 is configured as an electrically operable drive unit 20, which in the operating state is supplied with electrical energy by the energy supply devices 61, 62. The work apparatus 1 comprises two exchangeable power supply units 61, 62 in the form of battery packs, each having a plurality of cells. The energy supply devices 61, 62 are each accommodated in a compartment of the work apparatus 1 to form a plug connection.

The drive unit 20 and the energy supply devices 61 and 62 are integrated in a main body 1.1 of the work apparatus 1. The main body 1.1 is in particular the central component of the work apparatus 1 and is configured, for example, for handling the work apparatus 1. The main body 1.1 of the work apparatus 1 comprises further units and/or elements of the work apparatus 1, such as handles and/or handle tubes.

The work apparatus 1 comprises the boom 40. The boom 40 forms a supporting structure for arranging the tool 10 on the work apparatus 1. The boom 40 extends in a longitudinal direction X between the drive unit 20 and the tool 10. The longitudinal direction X is in particular the direction along which the boom 40 extends to its greatest length. In other words, the boom 40 is characterized in the longitudinal direction X by a maximum extension and thus by a maximum dimension.

At a free end of the boom 40, which is arranged away from the drive unit 20 in the longitudinal direction X, the boom 40 comprises the tool bearing unit 41 for rotatably supporting the tool 10 about the rotation axis R10. The tool bearing unit 41 is shown schematically. The rotation axis R10 extends essentially along a transverse direction Q and/or is arranged and/or oriented essentially parallel to a transverse direction Q. The transverse direction Q is, in particular, a direction which is arranged and/or oriented perpendicular to the longitudinal direction X.

Starting from the main body 1.1 of the work apparatus 1 and/or from the drive unit 20 in the direction to the tool bearing unit 41 and thus along the longitudinal direction X, the tool 10 is arranged on a first (left-hand) side with respect to the boom 40. Alternatively, it is possible that the boom 40 is configured for arranging the tool 10 on an opposite second (right-hand) side of the boom 40, in order, for example, to accommodate confined spatial conditions during processing, for example in transition regions of walls.

The drive unit 20 is coupled to the tool 10 via a drive means 30. The drive means 30 is schematically illustrated in FIG. 1 by a dashed line. In the embodiment of the work apparatus 1, the drive means 30 represents in particular a tension and/or compression means in the form of a drive belt, most preferably in the form of a drive V-belt (see also, for example, FIG. 4).

The drive means 30 is connected and/or coupled to respective drive elements 12, 300 of the tool 10 and the drive unit 20. With reference to FIG. 4, the drive element 12 is assigned to the tool 10 and the drive element 300 to the drive unit 20. The drive element 300 is arranged on the drive shaft 21 of the drive unit 20. The drive element 300 and the drive shaft 21 are described below with reference to FIGS. 4 and 5.

The drive means 30 is driven via the drive element 300. To ensure power transmission, it is necessary to preload the drive means 30 between the drive element 12 of the tool 10 and the drive element 300 of the drive unit 20 in a defined manner and thus apply a preload force to the drive means 30. The adjustment of the preload force can be carried out in particular by a displaceability of the boom 40 relative to the main body 1.1 of the work apparatus 1 along the longitudinal direction X. For this purpose, the boom 40 can comprise, for example, elongated holes which extend accordingly along the longitudinal direction X. The boom 40 can be fastened to the main body 1.1 of the work apparatus 1 by means of screw connections. For this purpose, the main body 1.1 can comprise threaded bolts which extend essentially in the transverse direction Q and protrude through the elongated holes of the boom 40. Alternatively, the tool bearing unit 41 can be mounted on the boom 40 so as to be displaceable in the longitudinal direction X and fastenable, in order to enable an adjustment and/or an adjustability of the drive means 30.

A cover housing part 100 is arranged on the boom 40. The cover housing part 100 extends essentially along the longitudinal direction X. The cover housing part 100 comprises a housing end edge 101, which is arranged facing toward the tool 10 in the transverse direction Q. The housing end edge 101 can adjoin the protective cover 11 of the tool 10 and/or contact it essentially flush, for example via a sealing element. The cover housing part 100 is configured to cover at least in sections the boom 40, the tool bearing unit 41, and/or the drive means 30 in order to initially provide, among other things, a basic protection against external influences.

The housing end edge 101 can lie in a plane and/or delimit the cover housing part 100 in a direction, in particular in the transverse direction Q. The housing end edge 101 can be correspondingly formed relative to a housing part opposite the cover housing part 100 in the transverse direction Q and can be characterized by a respective course along the longitudinal direction X (see also the illustration in FIG. 4).

In a view in the transverse direction Q, the housing end edge 101 extends or runs around the tool bearing unit 41 and/or around a drive element 12 of the tool 10 (see FIG. 4) and then along two opposite sides of the cover housing part 100 along the longitudinal direction X toward the drive unit 20.

The cover housing part 100 is releasably connected to the boom 40 via at least one screw connection and is thus movable in the course of the adjustment of the drive means 30 by moving the boom 40 along the longitudinal direction X.

In order to protect the boom 40 and the drive means 30, in particular in the area of the main body 1.1 of the work apparatus 1, a further cover housing part 400 is provided. The cover housing part 400 is fastened in particular to the main body 1.1 of the work apparatus 1 and is at least partially arranged on the boom 40.

The cover housing part 400 also extends essentially along the longitudinal direction X. The cover housing part 400 is configured to cover at least sections of the boom 40 and/or the drive means 30 in order to initially provide, among other things, a basic protection against external influences.

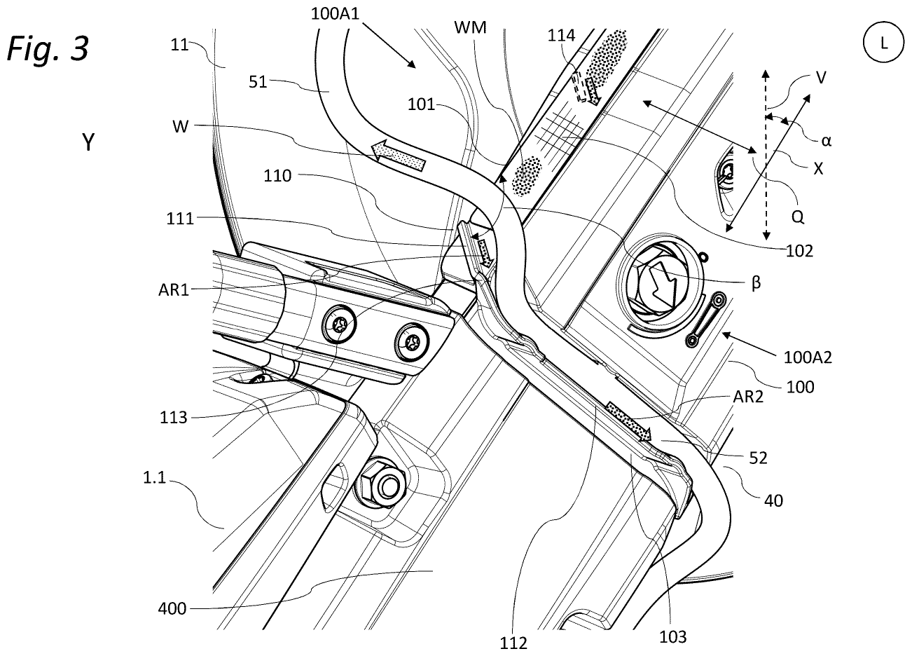

Accordingly, the work apparatus 1 comprises the two cover housing parts 100 and 400, of which the cover housing part 100 is arranged so as to be displaceable relative to and/or with respect to the cover housing part 400. The cover housing part 100 and the cover housing part 400 are configured and/or arranged in relation to each other in particular to form a plug connection essentially in the longitudinal direction X. For this purpose, the cover housing part 100 comprises a plug section 103, which is formed essentially complementary to a counter plug section of the cover housing part 400. The plug section 103 is more clearly visible in FIG. 3. The plug connection between the cover housing part 100 and the cover housing part 400 is accompanied by the formation of a gap S. In other words, a gap S is formed by the plug connection in the longitudinal direction X between the cover housing part 100 and the other cover housing part 400.

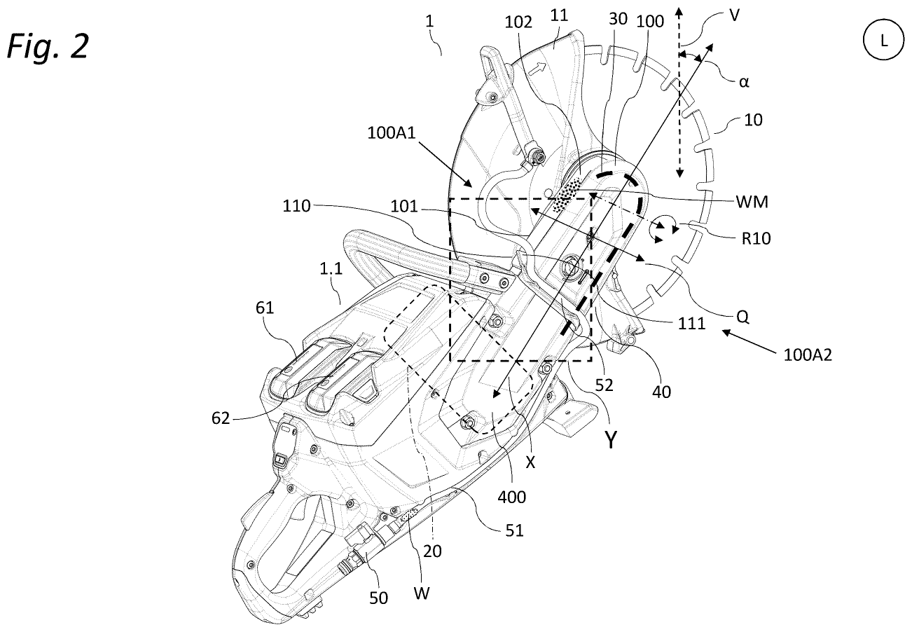

Due to manufacturing-related, assembly-related and/or operation-related factors, for example as a result of vibrations, the gap S between the cover housing parts 100 and 400 allows penetration of a medium W, WM in the direction of the boom 40 and/or the drive means 30, in particular in a defined location L of the work apparatus 1 (see FIGS. 2 and 3).

To avoid or at least significantly reduce a penetration of a medium W, WM, the cover housing part 100 comprises a drainage structure 110.

The drainage structure 110 is arranged on the cover housing part 100 with at least one drainage structure section 111. For the sake of simplicity, the term “at least one” in connection with the drainage structure section 111 is omitted below.

The drainage structure 110 comprises several drainage structure sections 111, 112, 113, 114 and/or can comprise several drainage structure sections 111, 112, 113, 114, which are arranged on different housing outer sides 100A1, 100A2 and which are described below with reference to further figures.

The drainage structure section 111 is formed, originating from the housing end edge 101, in a raised manner in order to delimit a flow surface 102 on the cover housing part 100 and/or of the cover housing part 100 for a flowing medium W, WM in and/or along the longitudinal direction X, and in particular to avoid a penetration of the medium W, WM into the gap S of the work apparatus 1, in particular when the work apparatus 1 is in a defined location L (see also FIGS. 2 and 3).

The drainage structure section 111 is raised starting from the housing end edge 101 in order to limit a flow surface 102 on the cover housing part 100 and/or of the cover housing part 100 for a flowing medium W, WM in and/or along the longitudinal direction X and, in particular, to prevent the medium W, WM from penetrating into the gap S of the work apparatus 1, especially when the work apparatus 1 is in a defined location L (see FIGS. 2 and 3).

In other words, the drainage structure section 111 forms a projection relative to the rest of the cover housing part 100, which extends originating from the housing end edge 101, in order to delimit an outer surface of the cover housing part 100, which forms a flow surface 102 for a medium W, WM, in the longitudinal direction X.

FIG. 2 shows the work apparatus 1 from FIG. 1 in a second perspective view, wherein the work apparatus 1 is in a second location. The second location is a defined location L, which is characterized by a defined position and/or, in particular, by a defined orientation of the work apparatus 1.

The drainage structure section 111 extends, on the one hand, along the longitudinal direction X toward the drive unit 20 and, on the other hand, along the transverse direction Q continuously, in particular steadily, away from the housing end edge 101, in order to collect the medium W, WM during the operating state in the defined location L of the work apparatus 1 and to discharge it in at least one discharge direction AR1, AR2 (see FIG. 3).

The defined location L comprises, in particular, an orientation of the work apparatus 1, in which the medium W, WM flows along the cover housing part 100 and, in particular, along the flow surface 102 in the direction of the drive unit 20, in particular as a result of the effect of a gravitational force.

The defined location L represents an orientation of the work apparatus 1 in which the boom 40 and/or the longitudinal direction X of the boom 40 points inclined upwards, so that the tool 10 is at a greater height than, for example, the drive unit 20 and/or the main body 1.1 of the work apparatus 1. In other words, in the defined location L, the boom 40 is arranged and/or oriented at an angle to a vertical line V, as illustrated in FIG. 2 by the angle of attack α.

FIG. 3 shows for further illustration a section of the work apparatus 1 from FIG. 2 (section Y) in an enlarged view. Clearly visible is the plug section 103 of the cover housing part 100 for forming a plug connection in the longitudinal direction X with the cover housing part 400, thereby forming the gap S (see FIG. 1).

The drainage structure 110 is, along a first flow direction AR1 and along a second flow direction AR2, each at the housing outer sides 1 00A1 and 100A 2 of the cover housing 100, at least in sections, characterized by a rib-shaped and by a channel-shaped or duct-shaped configuration. The drainage structure section 111 is formed at the housing outer side 100A1, in particular, as a rib 111, which extends essentially in a straight line across the flow surface 102 in order to delimit the flow surface 102 in the longitudinal direction X, in particular toward the drive unit 20. In a top view of the work apparatus 1, the rib 111 and the housing end edge 101 form, in the area and/or on the side of the flow surface 102, an angle of attack β, which is at least greater than 90°.

A further drainage structure section 112 of the drainage structure 110 is configured channel-shaped or duct-shaped. The drainage structure section 112 is formed on the housing outer side 100A2. The housing outer side 100A1 and the housing outer side 100A2 are arranged and/or oriented differently to each other, in particular oriented essentially perpendicularly to each other, in order to discharge the medium W, WM from the cover housing part 100 essentially without backflow.

As can be seen from the illustration in FIG. 3, the supply line 51 comprises a line section 52 which is formed to be shape-variable and/or essentially reversibly deformable. The drainage structure section 112 at the housing outer side 100A2 is configured to form a releasable essentially form-fitting, and/or a releasable essentially force-fitting connection with the line section 52, and is further configured to guide a medium W, WM together with the line section 52 in the drainage direction AR2.

The transition of the drainage structure section 111 into the drainage structure section 112, and thus from the housing outer side 100A1 to the housing outer side 100A2, takes place via the drainage structure section 113, in particular continuously and/or flush.

The drainage structure section 113 can be formed in a trough-shaped or a pocket-shaped manner in order to provide a barrier for the medium W, WM, or at least a portion of the medium W, WM in the form of water, for the transition from the housing outer side 100A1 to the housing side 100A2, and to partially retain the medium M, WM in the drainage structure section 113, thereby ensuring an improved further flow of the medium W, WM.

As can be seen from the illustration in FIG. 3, the drainage structure 110 can comprise a further drainage structure section 114, which is, in the longitudinal direction X and within the flow area 102, arranged spaced apart and/or opposite to the at least one drainage structure section 111, and which is formed, originating from the housing end edge 101, in a raised manner.

The drainage structure section 114 is formed in particular as a rib and is schematically indicated in FIG. 3 by a dashed line. The drainage structure section 114 is arranged at the housing side 100A1 within the flow surface 102 in order, in particular in the defined location L of the work apparatus 1, to delimit and/or discharge a first portion of the medium W, WM.

It is possible that, originating from the housing end edge 101, an extension of the drainage structure section 114 is smaller than an extension of the drainage structure section 111, which results, for example, in different proportions for discharging the medium W, WM. The drainage structure section 114 can be formed and/or arranged to discharge a larger portion of medium W, WM than the drainage structure section 111, or vice versa.

The drainage structure 100 is arranged, in the longitudinal direction X, in particular relative to the drive unit 20, in front of the plug section 103 of the cover housing part 100 and/or adjacent to the plug section 103 of the cover housing part 100.

The drainage structure 110 is, in particular together with the cover housing part 100, produced as a separate individual part, in particular produced integrally in one piece, for example by at least one of the following processes: an injection process, a casting process, a sintering process, a 3D printing process, a shrinkage process and/or a curing process.

The drainage structure 110 or respective sections, such as the drainage structure section 114, can alternatively also be produced as individual parts and connected to the cover housing part 100 by means of an essentially material-locking connection, for example by means of an adhesive connection.

By means of the drainage structure 110, a defined delimitation and/or drainage of a medium W, WM at the cover housing part 100 is ensured, which is accompanied by a reduced wear behavior of the work apparatus 1 and that the work apparatus 1 is subjected to reduced wear.

FIG. 4 shows the work apparatus 1 from FIG. 1 in a third perspective view, wherein the work apparatus 1 is shown partially in section and wherein some units and elements of the work apparatus 1 are hidden, for example the cover housing parts 100 and 400.

The work apparatus 1 comprises the drive unit 20. The drive unit 20 is configured as an electrically motor-driven drive unit 20. The location of the drive unit 20 within the main body 1.1 of the work apparatus 1 is indicated in FIG. 4 by a dashed line.

The drive shaft 21 forms the rotor of the drive unit 20. The drive unit 20 furthermore comprises the stator 22. The drive unit 20 can, for example, be configured as a brushless direct-current motor or can comprise a brushless direct-current motor. Alternatively, other configurations and/or formations of the drive unit 20 are possible.

The drive shaft 21 serves to transmit a generated torque in order to drive the tool 10 in an operating state. The drive shaft 21 is essentially cylindrical or at least cylindrical in sections. The drive shaft 21 extends in and/or along an axial direction AR. Furthermore, the drive shaft 21 is characterized by a rotational axis R21 about which the drive shaft 21 performs a rotational movement in an operating state of the drive unit 20.

The drive shaft 21 comprises the drive element 300 for coupling to the tool 10. The drive element 300 is connected to the drive means 30 in the form of the V-belt for coupling to the tool 10. The drive element 300 is formed as a belt pulley. Alternatively, the drive element 300 can be formed as a chain sprocket with a tooth profile for coupling with a tool chain in the form of a saw chain.

For the rotatable bearing and/or support of the drive shaft 21, two shaft bearing units 23 and 24 are provided, which are arranged at respective receiving sections and/or within respective receiving sections of a drive housing part 200 of the drive unit 20 and/or are supported in the axial direction AR of the drive shaft 21. The shaft bearing unit 23 is arranged at an end face of the drive housing part 200, which is characterized by a housing end face 201. The housing end face 201 is formed essentially planar (flat) and/or circular ring-shaped. An inner diameter of the housing end face 201 is configured such that, in particular taking into account manufacturing

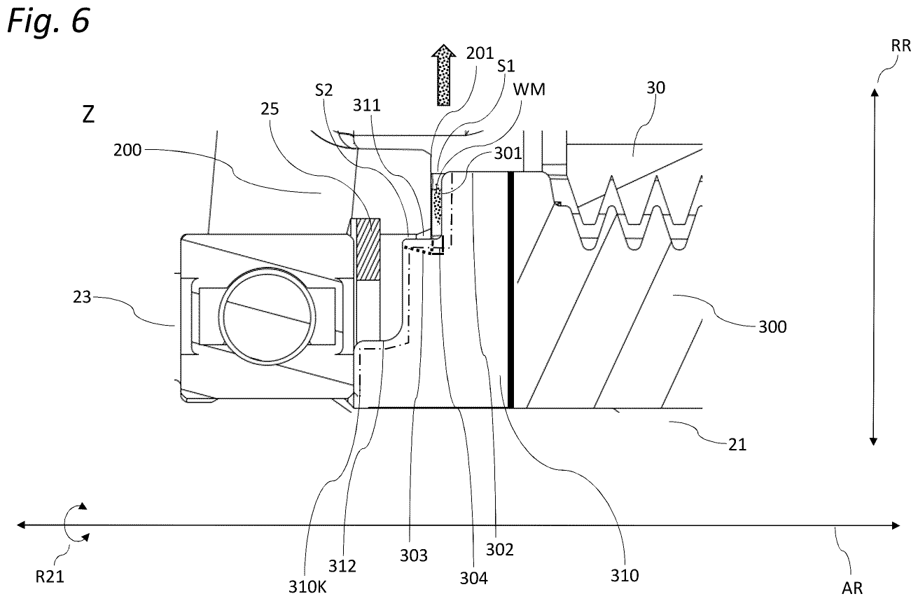

tolerances and/or assembly tolerances, the shaft bearing unit 23 can be received in the axial direction AR in the receiving section of the drive housing part 200. The shaft bearing unit 23 can be fastened within the drive housing part 200 by a retaining ring 25 (see in particular FIG. 6).

In the present embodiment, the shaft bearing units 23, 24 are formed as rolling bearing units with rolling elements in the form of balls, i.e., as so-called ball bearings. Alternatively, other configurations of rolling elements are also possible for the shaft bearing units 23, 24. Each of the shaft bearing unit 23, 24 each comprises an inner ring and an outer ring, between which the rolling elements are guided in a circumferential direction UR and/or roll off in each case.

The shaft bearing units 23, 24 are formed in particular as shaft bearing units 23, 24 known from the prior art. In other words, the shaft bearing units 23, 24 can be formed as standardized roller bearings of respective configuration.

Due to the location of the arrangement, the shaft bearing unit 23 can be equipped with a sealing disc or a sealing lip as standard in order to avoid, for example, a medium W, WM from penetrating into the section of the rolling elements. In this context, further a penetration of the medium W, WM through the shaft bearing unit 23 into an interior area of the drive unit 20 can also be essentially avoided.

The area between the shaft bearing unit 23 and the drive element 300 represents an area which, in a defined location L and/or during an operating state of the work apparatus 1, is or can be exposed to an arriving medium W, WM, in particular in the form of an arriving liquid and/or flowable mixture WM. For example, it is possible that a medium W, WM, in particular in the form of a mixture WM, present on the drive means 30 is transported via the drive means 30 to the area of the shaft bearing unit 23.

The arriving medium W, WM can potentially impair the shaft bearing unit 23, for example even if the shaft bearing unit 23 comprises a (standardized) sealing lip or sealing disc which is arranged on the side opposite the drive element 300. For example, the sealing lip or the sealing disk can gradually wear due to friction caused by the medium.

To protect the shaft bearing unit 23, a functional part 310 is arranged on the drive shaft 21. The functional part 310 is arranged on an outer side of the drive unit 20 and thus outside or at least partially outside the drive housing part 200. In other words, the functional part 310 is located outside the drive unit 20 and in particular outside the drive housing part 200.

The functional part 310 is in particular formed as an essentially rotationally symmetrical part and is, for example, defined by a maximum outer diameter and a minimum outer diameter. The functional part 310 is arranged, in the axial direction AR of the drive shaft 21, opposite to the shaft bearing unit 23 and (additionally) arranged at least partially spaced apart opposite to the drive housing part 200, in particular to the housing end face 201. In other words, the functional part 310 is arranged with the formation of a distance both to the shaft bearing unit 23 and with the formation of a distance to the drive housing part 200, in particular to the housing end face 201. In a view in and/or along the axial direction AR, the functional part 310 covers the shaft bearing unit 23 and at least in sections the drive housing part 200, that is, the housing end face 201.

The functional part 310 is configured and/or arranged to essentially keep a medium W, WM arriving during the operating state away from the shaft bearing unit 23, and to essentially convey and/or discharge it at the drive housing part 200, in particular at the housing end face 201, away in at least one direction RR, UR, in order to protect the shaft bearing unit 23 in particular. The functional part 310 is in particular configured and/or arranged, as a result of a rotational movement of the drive shaft 21 about the rotational axis R21, to subject the medium W, WM to a centrifugal force in order to accelerate the medium W, WM in the at least one direction RR, UR. The at least one direction RR, UR comprises a radial direction RR and/or a circumferential direction UR of the drive shaft 21 and/or of the drive element 300.

FIG. 5 illustrates, for closer clarification, the work apparatus 1 from FIG. 4 in a sectional view. Some units and elements of the work apparatus 1 are hidden and/or not visible, for example the tool 10. Additionally, FIG. 6 illustrates, for closer clarification, a section of the work apparatus from FIG. 5 (section Z) in an enlarged view.

The functional part 310 is, in the sectional view illustrated (section along the axial direction AR), characterized in the radial direction RR by a cascade-shaped contour profile 310K, in particular by a two-stage cascade-shaped contour 310K. The cascade-shaped contour 310K is formed by two functional steps 311 and 312 with different outer diameters (see in particular FIG. 5). The functional steps 311 and 312 each form cylindrical sections of the functional part 310, which each extend correspondingly along the axial direction AR.

The cover housing part 200 comprises the housing end face 201, and the functional part 310 comprises the functional end face 301. The housing end face 201 is, as already described, formed essentially planar (flat). The functional end face 301 is formed correspondingly to the housing end face 201 in particular also essentially planar (flat). In particular, the housing end face 201 and the functional end face 301 each lie in planes that are arranged essentially parallel to one another. In other words, the housing end face 201 and the functional end face 301 are each arranged essentially parallel to one another.

The housing end face 201 is characterized by a circular ring-shaped cross-section. The functional end face 301 is characterized by a circular ring-shaped cross-section.

In the axial direction AR, a conveying gap S1 is formed in particular between the housing end face 201 and the functional end face 301, in order, as a result of a rotational movement of the drive shaft 21 about the rotation axis R21, to set a medium W, WM located in the conveying gap S1 into a movement, in particular into

a rotational movement about the rotation axis R21, by means of the functional end face 301. As a result of the rotational movement of the drive shaft 21 and thus of the functional part 310, (active) conveying of the medium W, WM occurs in the radial direction RR and/or in the circumferential direction UR in the operating state, whereby the medium W, WM is essentially kept away from the shaft bearing unit 23.

It is possible that the conveying gap S1 expands or tapers, at least in sections, in the radial direction RR toward the functional outer surface 302 of the functional part 310. The conveying gap S1 can merge, in the radial direction RR toward the drive shaft 21, into the functional step 311 of the functional part 310. The functional step 311 limits the conveying gap S1 in the radial direction RR, in particular toward the drive shaft 21.

The functional step 311 extends in the axial direction AR toward the shaft bearing unit 23 and forms along the axial direction AR an axial gap S2 with the drive housing part 200, that is, with the corresponding receiving section for the shaft bearing unit 23. A width of the axial gap S2 in the radial direction RR can be at least equal to or smaller than a width of the conveying gap S1 in the axial direction AR.

The housing end face 201 extends in the radial direction RR, that is, in the direction toward the functional outer surface 302, at least as far as the functional end face 301 in the radial direction RR, in order to essentially convey away and/or discharge a medium W, WM conveyed in the radial direction RR and/or in the circumferential direction UR, at the housing end face 201. The circular ring-shaped cross-section of the housing end face 201 is at least equal to or, in particular, larger than the circular ring-shaped cross-section of the functional end face 301 (as can be seen, for example, from the illustration in FIG. 6 in connection with the spatial configuration of the respective parts 200 and 310).

It is additionally possible that the functional part 310, for example, comprises a retaining edge 303 and/or a groove 304, each of which extends in the circumferential direction UR around and/or along the functional part 310. The retaining edge 303 and/or the groove 304 are arranged at a defined radial position in the radial direction RR and/or at a defined axial position in the axial direction AR, which in the present embodiment is located at the functional step 311.

The retaining edge 303 and/or the groove 304 are in particular configured, after an operating state of the work apparatus 1 which is accompanied in particular by a parked location of the work apparatus 1 in a parking position, to retain, collect, and/or discharge a residual portion of medium W, WM from the functional part 310. A medium W, WM located within or at the functional step 311 can be prevented from continuing to flow in the direction of the shaft bearing unit 23 by the retaining edge 303 and/or groove 304. In FIG. 6, the configuration and/or location of a retaining edge 303 and/or a groove 304 on the functional step 311 is indicated by a dashed line.

In the embodiment of the work apparatus 1, the functional part 310 is a separate individual part. The functional part 310 can be produced in particular as a stepped ring-shaped individual part, for example by at least one of the following processes: a turning process, a milling process. In other words, the functional part 310 can be formed as a turned and/or milled part. The functional part 310 can be formed disc-shaped of a disc and act as a centrifugal disc 310 in relation to the medium M, WM.

The functional part 310 can, in particular depending on the configuration of the bearing unit 23 and/or the drive housing part 200 and thus depending on the location of the housing end face 201, be arranged (adjacent) to the drive element 300 or spaced apart from the drive element 300 along the axial direction AR. The arrangement of the functional part 310 at the drive element 300 and/or spaced apart from the drive element 300 can depend on further formations and/or configurations.

The functional part 310 can be arranged on the drive shaft 21 by forming an essentially form-fitting connection and/or an essentially force-fitting connection, for example in the form of a press connection.

The functional part 310 can be fastened to the drive element 300, for example by means of an essentially material-locking connection, which is produced, for example, by a welding process, in particular by a friction welding process. Alternatively, the functional part 310 can be produced integrally in one piece together with the drive element 300 as a separate individual part. The functional part 310 is comparatively easy to produce and mountable on the drive shaft 21.

With the functional part 310, in particular in combination with the drive housing part 200, an effective and/or sufficient protection of the shaft bearing unit 23 and, further, an interior area of the drive unit 20 against an arriving medium W, WM can be ensured.

The present invention is not limited to the embodiments described above. Rather, a variety of variants and modifications are possible which also make use of the inventive concept and therefore fall within the scope of protection. In particular, the present invention also claims protection for the subject matter and features of the dependent claims independently of the claims referred to.

### List of Reference Signs

1 work apparatus
1.1 main body of the apparatus
10 tool
11 protective cover
12 drive element
20 drive unit
21 drive shaft, rotor
22 stator
23 shaft bearing unit
24 shaft bearing unit
25 retaining ring
30 drive means
40 boom
41 tool bearing unit
50 supply unit
51 supply line
61 energy supply device
62 energy supply device
100 cover housing part
100A1 housing outer side
100A2 housing outer side
101 housing end edge
102 flow surface
103 plug section
110 drainage structure
111 drainage structure section
112 drainage structure section
113 drainage structure section
114 drainage structure section
200 drive housing part
201 housing end face
300 drive element
301 functional end face
302 functional outer surface
303 retaining edge
304 groove
310 functional part
310K contour profile
311 functional step
312 functional step
AR axial direction
AR1 drainage direction
AR2 drainage direction
L location
M material
Q transverse direction
R10 rotation axis
R21 rotation axis
RR radial direction
S gap
S1 conveying gap
S2 axial gap
UR circumferential direction
V vertical
W medium
WM medium, mixture
X longitudinal direction
α angle of attack
β angle of attack

What is claimed is:

1. A hand-held work apparatus for processing a material, comprising:
a tool which, in an operating state of the work apparatus, is configured for cutting, separating, and/or grinding the material;
a drive unit which is coupled to the tool via a drive means in order to drive the tool;
a boom which extends in a longitudinal direction between the drive unit and the tool and is configured to rotatably support the tool about a rotation axis by means of a tool bearing unit;
wherein a cover housing part is arranged on the boom, which extends along the longitudinal direction and comprises a housing end edge,
wherein a drainage structure with at least one drainage structure section is arranged on the cover housing part, which drainage structure section is formed, originating from the housing end edge, in a raised manner in order to delimit a flow surface on the cover housing part for a flowing medium in the longitudinal direction.

2. The work apparatus according to claim 1, wherein the at least one drainage structure section extends continuously along the longitudinal direction toward the drive unit and along the transverse direction away from the housing end edge, in order to collect the medium during the operating state in at least one defined location of the work apparatus and to discharge it in at least one drainage direction.

3. The work apparatus according to claim 2, wherein the at least one defined location comprises at least one position and/or at least one orientation of the work apparatus, in each case in which the medium flows along the cover housing part in the direction of the drive unit; and/or
wherein a gap is formed by a plug connection in the longitudinal direction between the cover housing part and a further cover housing part which is at least partially arranged on the boom.

4. The work apparatus according to claim 1, wherein the drainage structure is characterized, along at least one drainage direction, at least in sections by at least one of the following formations: rib-shaped, tube-shaped, channel-shaped, or duct-shaped, each with a semi-open profile or with a closed profile.

5. The work apparatus according to claim 1, wherein the at least one drainage structure section is formed as a rib, wherein, in a top view of the work apparatus, the rib forms an angle with the housing end edge which is at least greater than 90°.

6. The work apparatus according to claim 1, wherein the work apparatus comprises a supply unit with a supply line for providing a liquid medium at the tool in order to at least cool the tool and/or bind processed material during the operating state;
wherein the supply line comprises a line section which is formed to be shape-variable and/or reversibly deformable,
wherein the drainage structure comprises a second drainage structure section which is configured to form a releasable form-fitting and/or a releasable force-fitting connection with the line section, in order to guide the medium together with the line section in at least one drainage direction.

7. The work apparatus according to claim 1, wherein the drainage structure comprises a third drainage structure section between a first housing outer side of the cover housing part and a second housing outer side of the cover housing part, which is formed in a trough-shaped manner in order to provide a barrier for the medium to pass to the second outer housing side and to partially retain the medium in the third drainage structure section.

8. The work apparatus according to claim 1, wherein the drainage structure is arranged on at least a first housing outer side of the cover housing part and on a second housing outer side of the cover housing part,
wherein the first housing outer side and the second housing outer side are oriented differently to each other in order to discharge the medium without backflow.

9. The work apparatus according to claim 1, wherein the drainage structure comprises a fourth drainage structure section which is, in the longitudinal direction and within the flow surface, arranged spaced apart from the at least one drainage structure section and which is formed, originating from the housing end edge, in a raised manner;
wherein the at least one drainage structure section is arranged to discharge a first portion of the medium, and
wherein the fourth drainage structure section is arranged to discharge a second portion of the medium,
wherein the second portion is larger than the first portion.

10. The work apparatus according to claim 1, wherein the drainage structure is arranged, in the longitudinal direction relative to the drive unit, in front of a plug section of the cover housing part and/or adjacent to a plug section of the cover housing part, wherein the plug section is configured to form a plug connection with a further cover housing part which is at least partially arranged on the boom.

11. A hand-held work apparatus for processing a material, comprising:
a tool which, in an operating state of the work apparatus, is configured for cutting, separating, and/or grinding the material;
a drive unit which is coupled to the tool in order to drive the tool;
wherein the drive unit comprises a drive shaft with a drive element for coupling with the tool,
wherein a functional part is arranged on the drive shaft, which is arranged, in an axial direction of the drive shaft, spaced apart opposite to a shaft bearing unit and at least partially to a drive housing part of the drive unit for receiving the shaft bearing unit,
wherein the functional part is configured to keep a medium arriving during the operating state away from the shaft bearing unit, and to convey it away and/or discharge at the drive housing part in at least one direction.

12. The work apparatus according to claim 11, wherein the functional part is configured to subject the medium, as a result of a rotational movement of the drive shaft about a rotation axis, to a centrifugal force in order to accelerate the medium in the at least one direction.

13. The work apparatus according to claim 11, wherein, in a sectional view along the axial direction, the functional part is characterized, in a radial direction, by a cascade-shaped contour profile.

14. The work apparatus according to claim 11, wherein the drive housing part comprises a housing end face and wherein the functional part comprises a functional end face,
wherein, in the axial direction, a conveying gap is formed between the housing end face and the functional end face, in order, as a result of a rotational movement of the drive shaft about a rotation axis, to set a medium located in the conveying gap into a movement by means of the functional end face.

15. The work apparatus according to claim 14, wherein the housing end face and the functional end face are each formed planar and/or are each arranged parallel to each other, or
wherein the conveying gap expands, at least in sections, in a radial direction toward a functional outer surface of the functional part.

16. The work apparatus according to claim 14, wherein the conveying gap transitions, in a radial direction toward the drive shaft, into a functional step of the functional part, which limits the conveying gap in the radial direction,
wherein the functional step extends in the axial direction toward the shaft bearing unit and, along the axial direction, forms an axial gap with the drive housing part.

17. The Work apparatus according to claim 16, wherein a width of the axial gap in the radial direction is at least equal to or smaller than a width of the conveying gap in the axial direction.

18. The work apparatus according to claim 14, wherein, in a radial direction toward a functional outer surface of the functional part, the housing end face extends at least as far as the functional end face in the radial direction, in order to discharge medium conveyed in at least one direction at the housing end face.

19. The work apparatus according to claim 11, wherein the functional part comprises a retaining edge and/or a groove, each of which is arranged at a defined radial position in a radial direction and extends in a circumferential direction,
wherein the retaining edge and/or the groove is configured, after an operating state, to retain, collect, and/or discharge medium from the functional part.

20. The work apparatus according to claim 11, wherein the functional part is produced as a separate individual part, which is fastened to the drive element, arranged on the drive element or arranged spaced apart to the drive element, or
wherein the drive element is produced with the functional part as a separate individual part.
